(19) United States
(12) Patent Application Publication
(10) Pub. No.: US 2006/0040072 A1
(43) Pub. Date: Feb. 23, 2006

(54) Car antenna ornament

(76) Inventor: Todd P. Swanson, Kingwood, TX (US)

Correspondence Address: Richard C. Litman;LITMAN LAW OFFICES, LTD., P.O. Box 15035, Arlington, VA, 22215, US

(21) Appl. No.: 10/921,821

(22) Filed: Aug. 20, 2004

(51) Int. Cl. G09F 17/00; B60R 13/00; A47G 35/00

(52) U.S. Cl. 428/7; 428/8; 428/31; 428/542.2

(57) ABSTRACT

The car antenna ornament is a figurine for placement on a car antenna. The ornament has an elongated main body and a plurality of appendages extending from the elongated body. At least one appendage has at least one section and is rotatably connected to the main body by a joint. The ornament has an aperture dimensioned to receive a car antenna within it. The ornament is suspended either vertically or horizontally relative to the antenna. When the ornament is positioned on the antenna and the car is set in motion, the appendage rotates due to the force of the wind.

### BACKGROUND OF THE INVENTION

1. Field of the Invention

The present invention relates to devices attachable to a vehicle antenna, and particularly to an ornament for a car antenna.

2. Description of the Related Art

Ornaments for car antennas have a variety of uses. The ornaments may be used to assist the owner in finding the vehicle in question when the vehicle is parked in a large parking lot. They may be used for decorative purposes, to display patriotism with a national flag, show support for a school team, or advertise for a company. Additionally, ornaments may be placed on car antennas during funeral processions to indicate that specific vehicles are part of the procession.

While numerous car antenna ornaments exist, they are often stationary on the antenna. Stationary car antenna ornaments have become so ubiquitous that they fail to attract any attention. There is a need for a car antenna ornament that has at least one moving part that is capable of rotating in the wind, either when the vehicle is stationary in a strong wind, or when the vehicle is in motion, thereby attracting attention to the ornament.

Car ornaments or similar ornaments are shown or described in U.S. Design Pat. No. 280,807, issued Oct. 1, 1985 to E. Kaiser (combined vehicle ornament and advertising device); U.S. Pat. No. 383,137, issued Sep. 2, 1997 to E. Gamble, Jr. et al. (automobile antenna ornament); U.S. Pat. No. 387,772, issued Dec. 16, 1997 to D. Steinberg (antenna topper); U.S. Pat. Design Pat. No. 390,567, issued Feb. 10, 1998 to E. Gamble, Jr. et al. (automobile antenna ornament); U.S. Design Pat. No. 404,738, issued Jan. 26, 1999 to M. Augusta (baseball player antenna-topper); U.S. Design Pat. No. 404,739, issued Jan. 26, 1999 to M. Augusta (football player antenna-topper); U.S. Design Pat. No. 413,330, issued Aug. 31, 1999 to M. Augusta (basketball player antenna-topper); U.S. Design Pat. No. 424,569, issued May 9, 2000 to M. Augusta (surfer antenna-topper); U.S. Design Pat. No. 425,901, issued May 30, 2000 to M. Augusta (soccer player antenna-topper); U.S. Design Pat. No. 427,184, issued Jun. 27, 2000 to R. Peters (antenna topper shaped like a flaming eyeball); U.S. Design Pat. No. 441,742, issued May 8, 2001 to M. Augusta (snowboarder antenna-topper); U.S. Design Pat. No. 443,544, issued Jun. 12, 2001 to T. Place (ornamental topper for vehicle antenna); and U.S. Design Pat. No. 450,685, issued Nov. 20, 2001 to M. Augusta (snowboarder antenna-topper).

Additional car ornaments or similar ornaments are shown in U.S. Patent Publication No. 2003/0116076, published Jun. 26, 2003 and applied for by F. Hoyos (car spinning display); U.S. Patent Publication No. 2003/0145777, published Aug. 7, 2003 and applied for by V. Lorenzana et al. (antenna mounted flag); U.S. Pat. No. 1,435,106, issued Nov. 7, 1922 to M. Comiskey (automobile ornament); U.S. Pat. No. 1,441,261, issued Jan. 9, 1923 to G. Ackman, Jr. (aerial device); U.S. Pat. No. 1,524,313, issued Jan. 27, 1925 to C. Rumohr (aeroplane toy); U.S. Pat. No. 1,531,566, issued Mar. 31, 1925 to S. Moiseve et al. (toy aeroplane); and U.S. Pat. No. 1,927,399, issued Sep. 19, 1933 to H. Godman (miniature airplane).

Further car ornaments or similar ornaments are shown in U.S. Pat. No. 5,027,539, issued Jul. 2, 1991 to J. Orsini (pole restrained kite or airfoil); U.S. Pat. No. 5,665,438, issued Sep. 9, 1997 to I. Lee et al. (antenna accessory for vehicle identification); U.S. Pat. No. 5,836,261, issued Nov. 17, 1998 to D. Sutton (vehicle antenna topper); U.S. Pat. No. 6,063,459, issued May 16, 2000 to S. Velte (antenna ornament); U.S. Pat. No. 6,197,390, issued Mar. 6, 2001 to B. LaVite (multi-purpose vehicle ornament); U.S. Pat. No. 6,247,423, issued Jun. 19, 2001 to S. Ingram et al. (antenna cover apparatus); U.S. Pat. No. 6,278,408, issued Aug. 21, 2001 to E. Segovia, Jr. (vehicle antenna display system); U.S. Pat. No. 6,598,556, issued Jul. 29, 2003 to R. Peters (aerodynamic wind riding antenna ornament); U.S. Pat. No. 6,609,476, issued Aug. 26, 2003 to V. Lorenzana et al. (antenna mounted flag); U.S. Pat. No. 6,678,979, issued Jan. 20, 2004 to A. Lim et al. (wind indicator); U.K. Patent No. 2,037,467, published Jul. 9, 1980 (visible-signaling device); and Japanese Patent No. 58-56941, published Apr. 4, 1983 (ornament for car).

None of the above inventions and patents, taken either singly or in combination, is seen to describe the instant invention as claimed. Thus a car antenna ornament solving the aforementioned problems is desired.

### SUMMARY OF THE INVENTION

The car antenna ornament is a figurine for placement on a car antenna. The ornament has an aperture dimensioned to receive a car antenna within it. The figurine has at least one limb that is rotatable. When the ornament is positioned on the antenna and the car is set in motion, the limb(s) rotates due to the force of the wind.

The car antenna ornament has an elongated main body and a plurality of appendages extending from the elongated body. At least one of the appendages has a joint that allows for movement of the appendage. The ornament is placed on the antenna, and the car is set in motion. Once movement of the car commences, each appendage that has a joint will rotate due to the force of the wind.

The main body has an aperture defined therein, which is dimensioned to receive the car antenna. The aperture is defined within the elongated body such that upon insertion of the antenna into the aperture, the body is either aligned along the longitudinal axis of the antenna or aligned perpendicular to the antenna. The ornament is therefore either suspended vertically or horizontally on top of the antenna.

Additionally, the aperture may extend through the entire body of the ornament, allowing the antenna to pass through it. The ornament may then slide down the antenna and be positioned where the user prefers. The ornament is held on the antenna at a specific position due to friction between the antenna and the inside of the ornament.

The ornament may be a sports figurine, an animal, or any figurine for which rotatable limbs would be appropriate. The ornament may have a number of appendages that are movable or only one, depending on the design of the figurine.

The appendages may have a plurality of sections and one or more ball and socket joints. The joints attach the appendages to the main body and are additionally located between two sections of an appendage. The appendage is therefore rotatable relative to the main body, and the sections of the appendage are rotatable relative to each other. Once the car is put in motion, the appendages are capable of capturing air movement and translating the air movement into rotational movement of the sections of the appendages.

The ornament may be made from a plastic or other synthetic material.

These and other features of the present invention will become readily apparent upon further review of the following specification and drawings.

### BRIEF DESCRIPTION OF THE DRAWINGS

FIG. 1 is an environmental, perspective view of a car antenna ornament according to a first embodiment of the present invention.

FIG. 2 is an environmental elevational front view of the car antenna ornament according to the first embodiment of the present invention.

FIG. 3 is an environmental perspective view of a car antenna ornament according to a second embodiment of the present invention.

FIG. 4 is an environmental perspective view of the car antenna ornament according to the second embodiment of the present invention with the antenna extended through the ornament.

Similar reference characters denote corresponding features consistently throughout the attached drawings.

### DETAILED DESCRIPTION OF THE PREFERRED EMBODIMENTS

The present invention is a car antenna ornament, designated generally as 10 in the drawings. The car antenna ornament 10 has an aperture dimensioned to receive a car antenna within it. The ornament has at least one that is rotatable. When the ornament 10 is positioned on the antenna and the car is set in motion, the limb rotates due to the force of the wind.

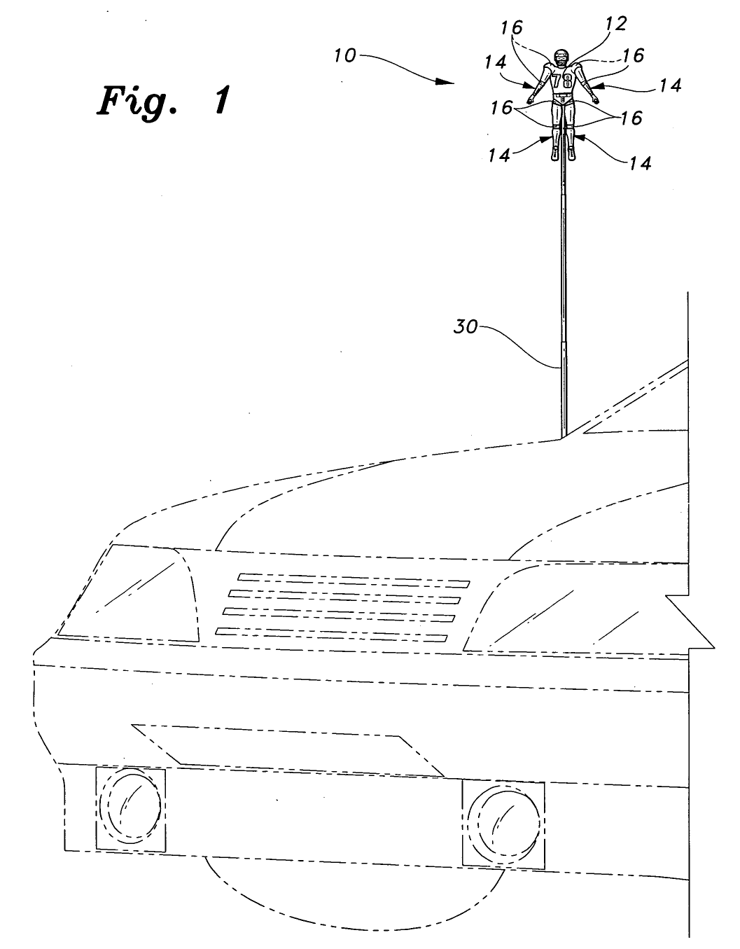

FIG. 1 shows the car antenna ornament 10 situated on the car antenna 30. The ornament 10 is adapted to receive the antenna 30. The ornament 10 has a main body 12 and a plurality of appendages 14 extending from the main body 12. The appendages 14 have joints 16 that allow for movement of the appendages 14. The ornament 10 is placed on the antenna 30, and the car is set in motion. Once movement of the car commences, each appendage 14 that has a joint 16 will rotate due to the force of the wind.

The ornament 10 may be a sports figurine, an animal, or any figurine for which rotatable limbs would be appropriate. The ornament 10 may have a number of appendages 14 that are movable or only one, depending on the design of the figurine.

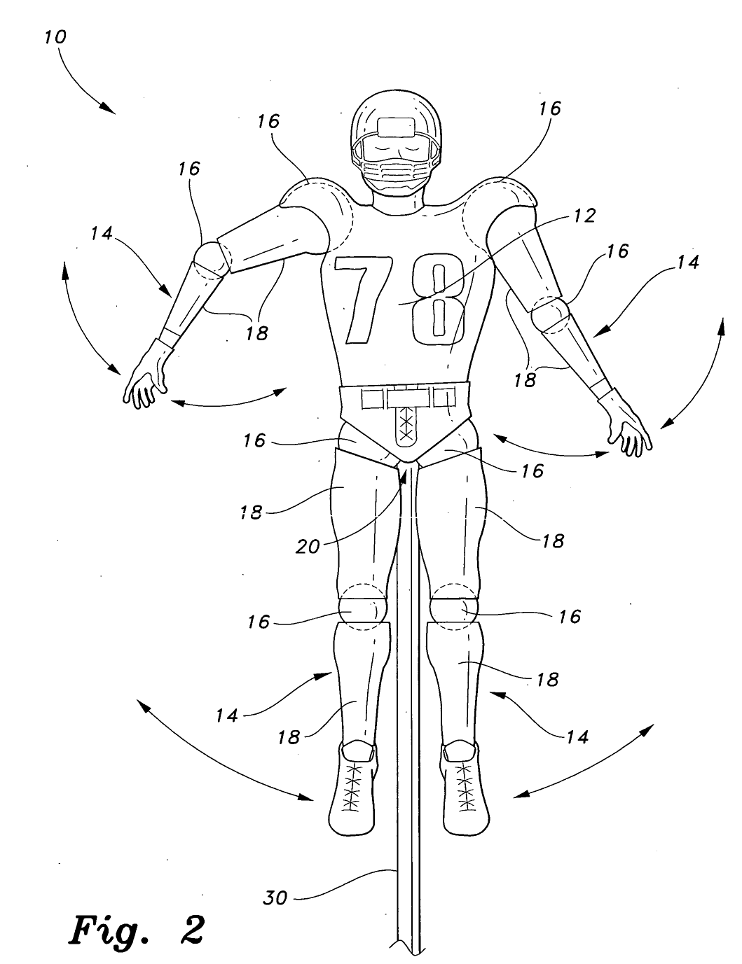

Turning now to FIG. 2, the car antenna ornament 10 is shown attached to the car antenna 30. The ornament 10 has an elongated main body 12 and a plurality of appendages 14 extending from the main body 12. The appendages 14 are generally limbs of a figurine or animal. The main body 12 has an aperture 20 defined therein, which is dimensioned to receive the car antenna 30. The body 12 is positioned on the antenna 30, and the antenna 30 is inserted into the aperture 20. The aperture 20 is defined within the elongated body 12 such that upon insertion of the antenna 30 into the aperture 20, the elongated body 12 is aligned along the longitudinal axis of the antenna 30. This alignment suspends the ornament 10 vertically on top of the antenna 30.

The appendages 14 may have a plurality of sections 18 and one or a plurality of joints 16. The joints 16 attach the appendages 14 to the main body 12. The joints 16 are additionally located between two sections 18 of an appendage 14. The appendage 14 is therefore rotatable relative to the main body 12, and the sections 18 of the appendage 14 are rotatable relative to each other. Once the car is put in motion, the appendages 14 are capable of capturing air movement and translating the air movement into rotational movement of the sections 18.

The joints 16 are ball and socket joints 16, but may be any type of joint that allows for rotational movement of the sections 18 relative to each other or the appendage 14 relative to the main body 12.

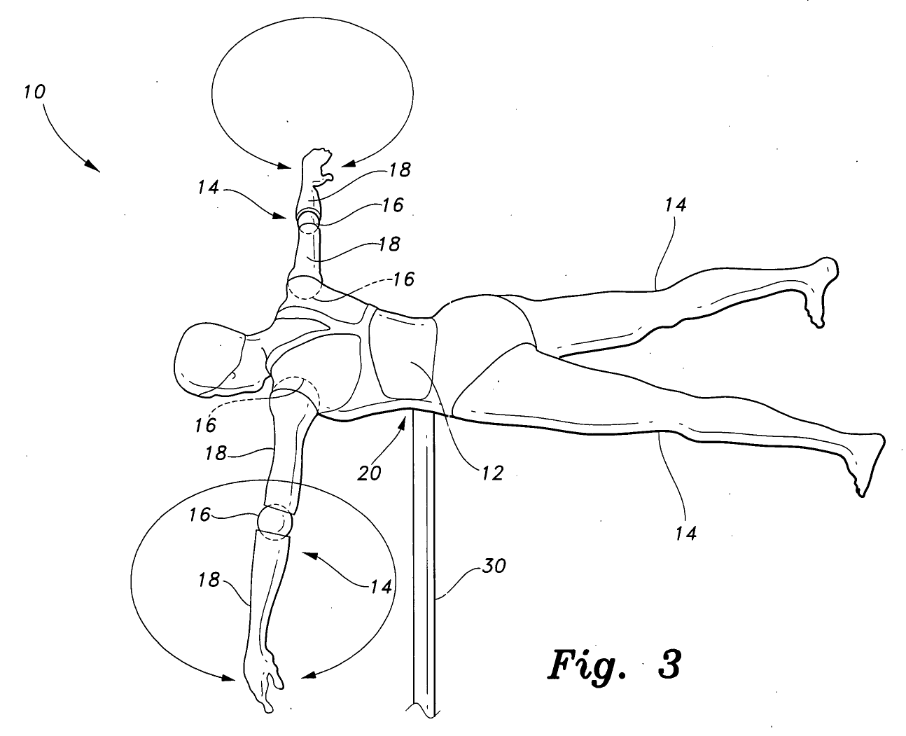

FIG. 3 shows another embodiment of the car antenna ornament 10 affixed to the car antenna 30. The aperture 20 is defined within the elongated main body 12 such that upon insertion of the antenna 30 into the aperture 20, the elongated body 12 is aligned perpendicular to the longitudinal axis of the antenna 30. This alignment suspends the ornament 10 horizontally on top of the antenna 30. The horizontal alignment of the main body 12 of the ornament 10 is a more appropriate layout for figurines depicting motions such as swimming. The appendages 14 are connected to the main body 12 by joints 16. A plurality of joints 16 connects sections 18 of the appendages 14 to each other. The appendages 14 and sections 18 of the appendages 14 are rotatable upon movement by the car.

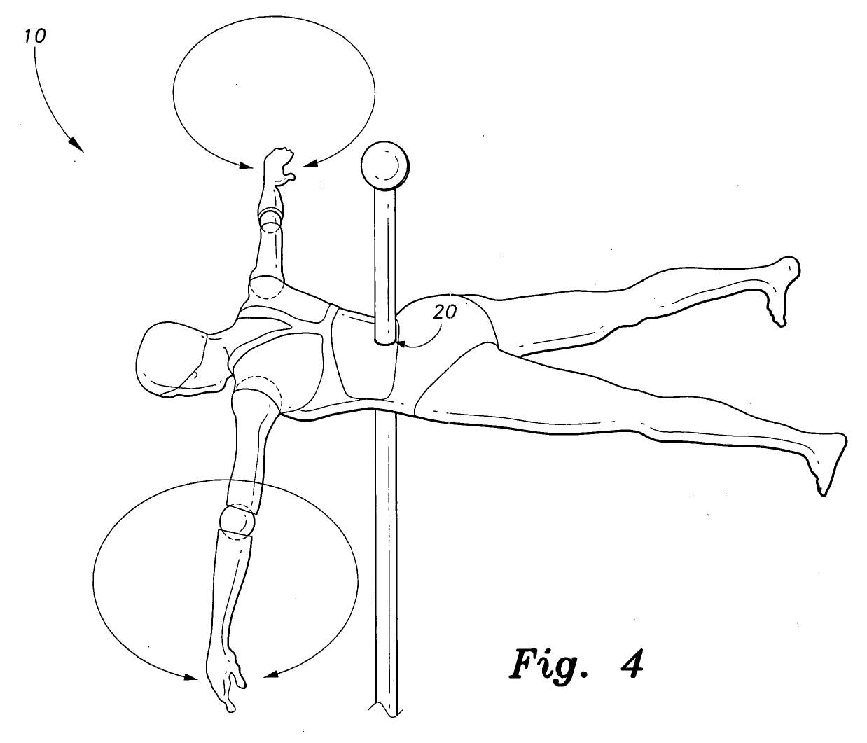

FIG. 4 shows the car antenna ornament 10 with the aperture 20 extended through the entire body 12 of the ornament 10, allowing the antenna 30 to pass through the ornament 10. The ornament 10 may then be slid down the antenna 30 and positioned where the user prefers. The ornament 10 is held on the antenna 30 at a specific position due to friction between the antenna 30 and the inside of the ornament 10. Multiple ornaments 10 would thereby be able to fit on the antenna 30.

The ornament 10 may be made from a plastic material or a synthetic material. The ornament 10 may additionally be made from any material that allows motion of the parts.

It is to be understood that the present invention is not limited to the embodiments described above, but encompasses any and all embodiments within the scope of the following claims.

I claim:

1. An ornament for an car antenna, comprising:
a main body having an aperture defined therein adapted for receiving the car antenna; and
at least one appendage extending from the main body, the appendage having at least two sections;
a joint rotatably connecting the two sections to each other, the appendage being capable of capturing air movement and translating the air movement into rotational movement of the sections.

2. The ornament according to claim 1, wherein said joint is a ball and socket joint.

3. The ornament according to claim 1, wherein said main body is a figurine.

4. The ornament according to claim 1, wherein said appendage is a limb.

5. The ornament according to claim 1, wherein the main body is elongated.

6. The ornament according to claim 5, wherein the aperture is defined parallel to a longitudinal axis of the elongated body.

7. The ornament according to claim 5, wherein the aperture is defined perpendicular to the longitudinal axis of the elongated body.

8. The ornament according to claim 1, wherein the ornament is made from a plastic material.

9. The ornament according to claim 1, wherein the ornament is made from a synthetic material.

10. An ornament for a car antenna, comprising:
a main body having an aperture defined therein adapted for receiving the car antenna; and
at least one appendage extending from the main body, the appendage having at least one section;
a ball and socket joint rotatably connecting the appendage to the main body, the appendage being capable of capturing air movement and translating the air movement into rotational movement of the appendage.

11. The ornament according to claim 10, wherein the main body is a figurine.

12. The ornament according to claim 10, wherein the appendage is a limb.

13. The ornament according to claim 10, wherein the main body is elongated.

14. The ornament according to claim 13, wherein the aperture is defined within the elongated body parallel to a longitudinal axis of the elongated body.

15. The ornament according to claim 13, wherein the aperture is defined within the elongated body perpendicular to the longitudinal axis of the elongated body.

16. The ornament according to claim 10, wherein the ornament is made from a plastic material.

17. The ornament according to claim 10, wherein the ornament is made from a synthetic material.
